(19) United States
(12) Patent Application Publication
(10) Pub. No.: US 2013/0108522 A1
(43) Pub. Date: May 2, 2013

(54) Self Locking Snap Plate

(71) Applicants: Jesse B. Cohen, San Diego, CA (US); Matthew Paul Fried, San Diego, CA (US)

(72) Inventors: Jesse B. Cohen, San Diego, CA (US); Matthew Paul Fried, San Diego, CA (US)

(73) Assignee: MOLECULAR BIOPRODUCTS, INC., San Diego, CA (US)

(21) Appl. No.: 13/282,694

(22) Filed: Oct. 27, 2011

(51) Int. Cl. B01L 3/00

(52) U.S. Cl. 422/552

(57) ABSTRACT

A pipette tip tray for use with a standardized rack. The pipette tip tray includes an uppermost surface defining a first plane and a lowermost surface defining a second plane. A deck is located between the first and second planes and includes a plurality of shaft apertures extending therethrough. Each of the shaft apertures has a size or shape configured to receive the shaft of a pipette tip. The tray further includes a first locking element located below the second plane.

### FIELD OF THE INVENTION

The present invention relates generally to pipette tip trays and, more particularly, to pipette tip tray and rack assemblies.

### BACKGROUND OF THE INVENTION

The presence of automated and robotic instruments has been, and continues to be, increasing in the modern-day laboratory. With the increased reliance on batch-mode processing by robotic instrumentation, there has developed a series of standardized structures, shapes, and sizes for consumable labware products that enable different instruments, perhaps by different manufacturers, to handle the same prepared samples.

With the drive to structural standards, there is a growing need to utilize basic components of a particular labware product in multiple commercially-available products. For example, pipetting tips are commercially-available in a wide range of sizes and volumes (ranges include volumes greater than 1 mL and as small as 1 μL). Each size of the commercially-available pipette tip may be stored in a tray and rack assembly for ease use.

However, the arrangement of the pipette tips with respect to the tray and rack may for one size and volume of pipette tip may vary significantly from another size and volume of pipette tip. Therefore, unique trays and/or racks are needed for each size and volume combination.

While some interchangeable pipetting tip tray and rack assemblies have been developed, the manufacturing methods are complex. That is, these conventional methods typically include complex tools and/or specialized adhesives for interfacing an interchangeable tray with a standardized rack and vice versa.

Thus, there exists a need to improve the adaptability of the basic components of tray and rack assemblies to promote further robotic integration while minimizing manufacture costs. Additionally, modes of manufacturing the adaptable rack assemblies should minimize the need for specialized tools, which will further reduce manufacturing costs.

### SUMMARY OF THE INVENTION

The present invention overcomes the foregoing problems and other shortcomings, drawbacks, and challenges of interfacing a conventional pipette tip trays for use with a standardized rack. While the invention will be described in connection with certain embodiments, it will be understood that the invention is not limited to these embodiments. To the contrary, this invention includes all alternatives, modifications, and equivalents as may be included within the spirit and scope of the present invention.

In accordance with one embodiment of the present invention, a pipette tray includes an uppermost surface defining a first plane and a lower surface defining a second plane. A deck is located between the first and second planes and includes a plurality of shaft apertures extending therethrough. Each of the shaft apertures has a size or shape configured to receive a shaft of a pipette tip. The tray also includes a first locking element that is located below the second plane.

According to another embodiment of the present invention, a pipette rack assembly includes a pipette tip tray and a rack. The pipette tip tray includes an uppermost surface defining a first plane and a lower surface defining a second plane. A deck is located between the first and second planes and includes a plurality of shaft apertures extending therethrough. Each of the shaft apertures has a size or shape configured to receive a shaft of a pipette tip. The tray also includes at least one locking element that is located below the second plane. The rack has a surface and at least one sidewall that extends downwardly from the surface. At least one receiving element is on the surface of the rack and is vertically aligned with the at least one locking element of the pipette tip tray when the pipette tip tray is positioned over the rack. When the at least one locking element is coupled to the at least one receiving element, the pipette tip tray is secured to the rack.

Still another embodiment of the present invention is directed a variable pipette rack system that includes a plurality of pipette tip trays and a rack. Each of the pipette tip trays includes an uppermost surface defining a first plane and a lower surface defining a second plane. A deck is located between the first and second planes and includes a plurality of shaft apertures extending therethrough. Each of the shaft apertures has a size or shape configured to receive the shaft of a pipette tip. Each tray also includes a first locking element that is located below the second plane. The rack has a surface and at least one sidewall that extends downwardly from the surface. A plurality of receiving element is on the surface of the rack. At least one of the receiving elements is in vertical alignment with the at least one locking element of a select one of the plurality of pipette tip trays when the select one is positioned over the rack. When the at least one locking element of the select one of the plurality of pipette tip trays is coupled to a corresponding one of the plurality of receiving elements, the selected pipette tip tray is secured to the rack.

The above and other objects and advantages of the present invention shall be made apparent from the accompanying drawings and the descriptions thereof.

### BRIEF DESCRIPTION OF THE DRAWINGS

The present invention overcomes the foregoing problems and other shortcomings, drawbacks, and challenges of manufacturing a pipetting tip tray that is configurable and that may be coupled to a standardized rack while minimizing manufacturing costs. While the invention will be described in connection with certain embodiments, it will be understood that the invention is not limited to these embodiments. To the contrary, this invention includes all alternatives, modifications, and equivalents as may be included within the spirit and scope of the present invention.

FIG. 1 is an exploded view of a pipette tip tray with a plurality of pipette tips and rack configured to receive the pipette tip tray.

FIG. 2 is a bottom view of the pipette tip tray of FIG. 1.

FIG. 3 is an enlarged view of a portion of the bottom of the pipette tip and including a locking element.

FIG. 4 is a perspective view of the rack of FIG. 1.

FIG. 5 is a perspective view of the assembled pipette tip tray and rack with the plurality of pipette tips.

FIG. 6 is a cross-sectional view of the assembled pipette tip tray and rack, taken along the line 6-6 in FIG. 5.

FIGS. 7A-7E are cross-sectional views of pipette tip trays in accordance with other embodiments of the present invention.

### DETAILED DESCRIPTION OF THE INVENTION

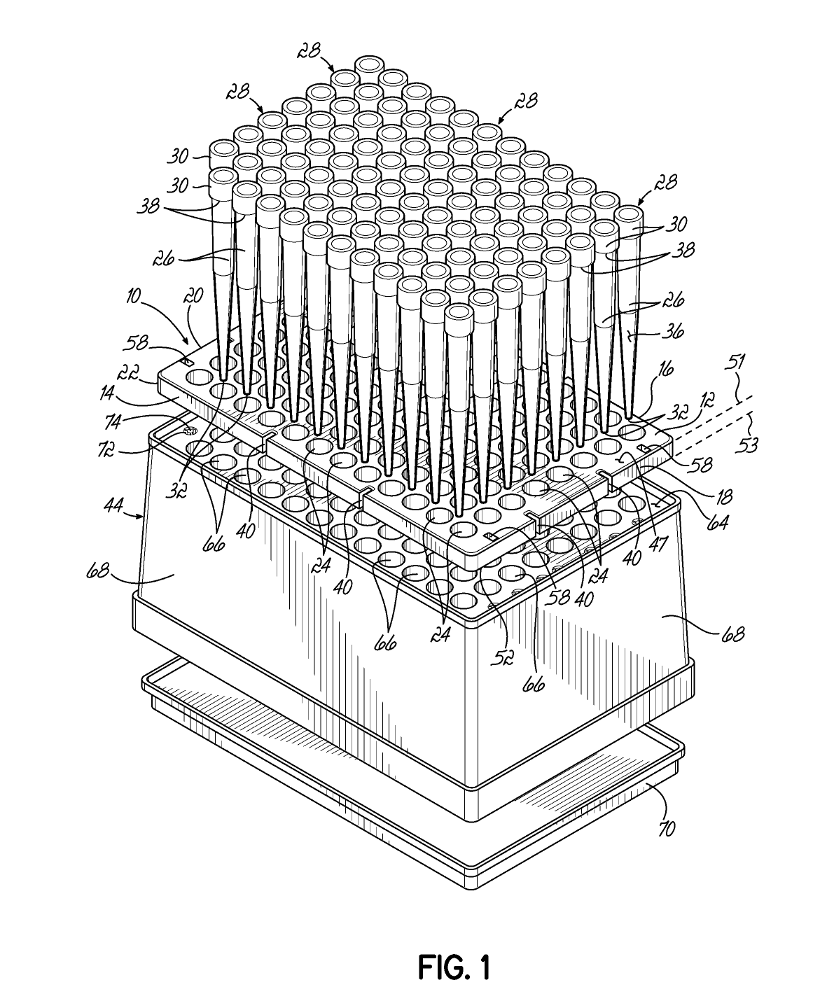

Turning now to the figures, and particularly to FIG. 1, a pipette tip tray (“tray” 10) is shown and described in detail according to one embodiment of the present invention. The tray 10 may be molded as a unitary structure from a suitable polymeric material and includes a deck 12 having a pair opposing longitudinal side edges 14, 16 and a pair of opposing lateral side edges 18, 20 with a skirt 22 depending from at least one of the pair of longitudinal side edges 14, 16 and/or the pair of lateral side edges 18, 20. In the embodiment shown, the skirt 22 depends from each of the pair of opposing longitudinal side edges 14, 16 and the pair of lateral side edges 18, 20.

The deck 12 includes a plurality of apertures 24 having a size or shape that is configured to receive the shaft 26 of a pipette tip 28 (“shaft apertures” 24). While the illustrated embodiment herein includes 96-shaft apertures, it would be understood that the various features described herein may be applied to other pipette tip trays having other numbers of shaft apertures (for example, 384-shaft apertures).

The pipette tips 28 may be of any desired size, but are particularly illustrated as medium sized pipette tips, e.g., 20 μL to 300 μL sized pipette tips. Each pipette tip 28 includes a molded hub 30 on one end of the shaft 26, which is configured to create a seal with a pipetter (not shown), a distal tip end 32 on an opposing end of the shaft 26, and a lumen (not shown) extending therebetween. Generally, an outer surface 36 of the pipette tip 28 tapers from the about the hub 30 to the distal tip end 32 but for a shelf 38 at a distal end of the hub 30. The shelf 38 is configured to reside on the deck 12 and to create a positive stop for the pipette tip 28 with respect to the tray 10.

Thus, the shaft apertures 24 are generally sized and shaped to accommodate the particular pipette tip size and to reduce movement of the pipette tip 28 within the shaft aperture 24 when seating the pipetter shaft (not shown) with the hub 30 of the pipette tip 28.

The shaft apertures 24, as shown, are arranged into a plurality of rows, generally parallel to the pair of opposing longitudinal side edges 14, 16. One of ordinary skill in the art will readily appreciate that the number of shaft apertures 24 comprising each longitudinal row is not limited to the particular number of the illustrated embodiment in FIG. 1. Instead, the number of shaft apertures 24 in each row may be altered to the particular intended use, as indicated below with respect to a rack, or as otherwise desired. It will be readily appreciated that the shaft apertures 24 may also align into respective columns along the lateral side edges 18, 20, although the shaft apertures 24 are generally referred herein as being in longitudinal rows.

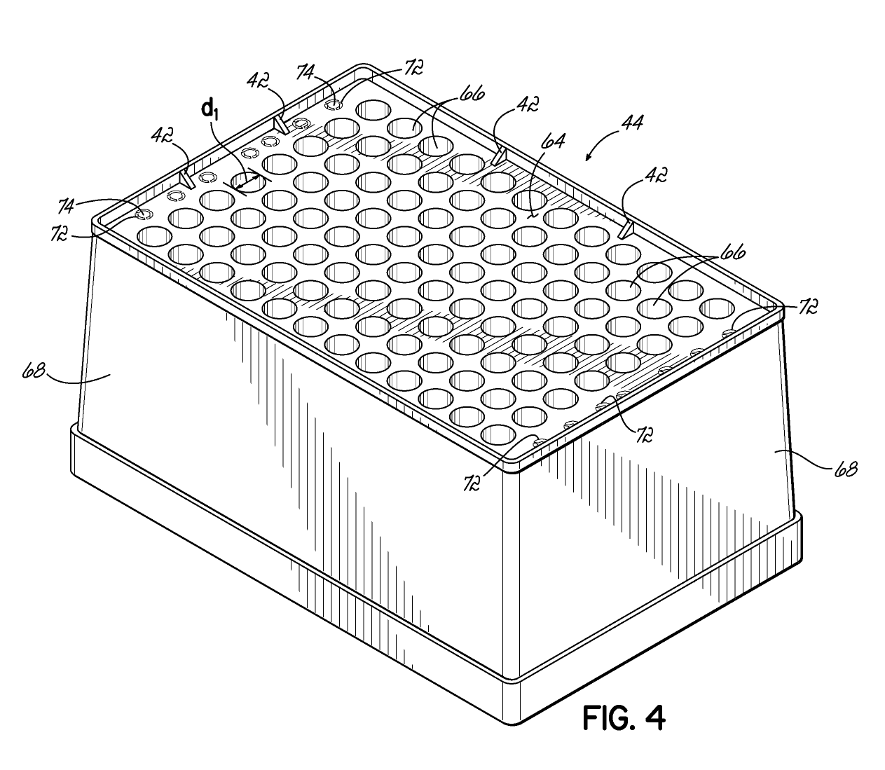

The skirt 22 and the deck 12 may include one or more slots 40 extending inwardly from the side edges 14, 16, 18, 20 and that are shaped and sized to accommodate structural ribs 42 (FIG. 4) of a rack 44. The structural ribs 42 may further facilitate alignment of the tray 10 with respect to the rack 44, as provided in greater detail below.

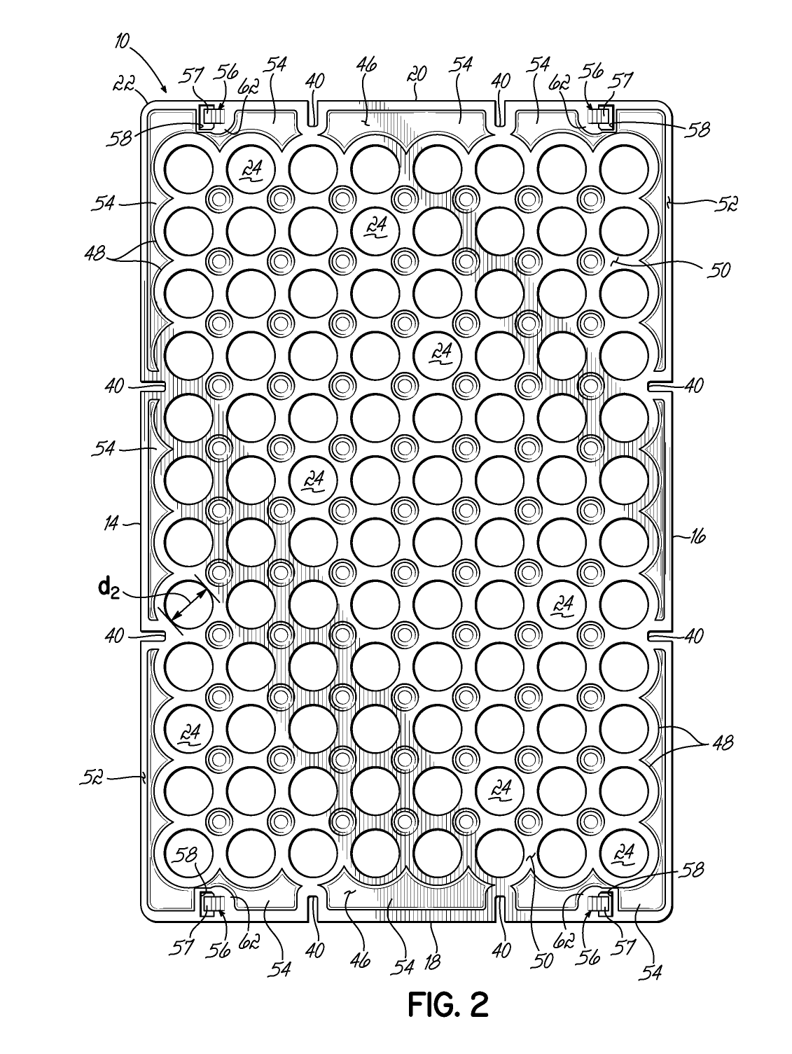

In FIG. 2, a bottom view of the tray 10 is shown and includes a bottom surface 46, which is located opposite a tip surface 47 (FIG. 1). A plurality of molded annular sleeves 48 extend downwardly from the bottom surface 46 and are located circumferentially around each of the shaft apertures 24. While the annular sleeves 48 are not required, their inclusion provides additional strength and stability to the tray 10 to resist a downwardly-directed force that may be applied when inserting the pipetter (not shown) into the hub 30 of a pipette tip 28. Also not required but illustrated herein, each annular sleeve 48 is co-extensive with an adjacent annular sleeve 48 so as to define a bottom surface 50 of the annular sleeves 48. In the illustrative embodiment, the bottom surface 50 of the annular sleeves 48 is co-planar with a bottom edge 52 of the skirt 22 and may, in fact, be contiguous with portions of the bottom surface 50 of the molded annular sleeves 48. As a result, the tray 10 includes an uppermost surface (corresponding to the tip surface 47 herein) and a lower surface (corresponding to the coextensive bottom surface 50 of the annular sleeves 48 and the skirt 22, respectively). The upper surface defines a first plane 51 and the lower surface defines a second plane 53 such that the deck 12 is located between the first and second planes 51, 53.

One or more recesses 54 may be provided between the skirt 22 and the annular sleeves 48 to reduce the weight of the tray 10 and to minimize manufacturing costs. It would be readily appreciated that other combinations of structures may be used. For instance, the deck 12 and the annular sleeves 48, if provided, may be constructed with a generally uniform thickness and the skirt may extend downwardly farther than the annular sleeves 48 and/or the bottom surface 50, for example. In this embodiment, the tip surface 47 of the tray 10 defines a first plane and the lowermost edge of the skirt 22 defines the second plane. Alternatively, the deck 12 may have a generally uniform thickness without being provided with the annular sleeves 48 or skirt 22. In this instance, the tip surface 47 of the tray 10 defines the first plane and the bottom surface 46 of the tray 10 defines the second plane.

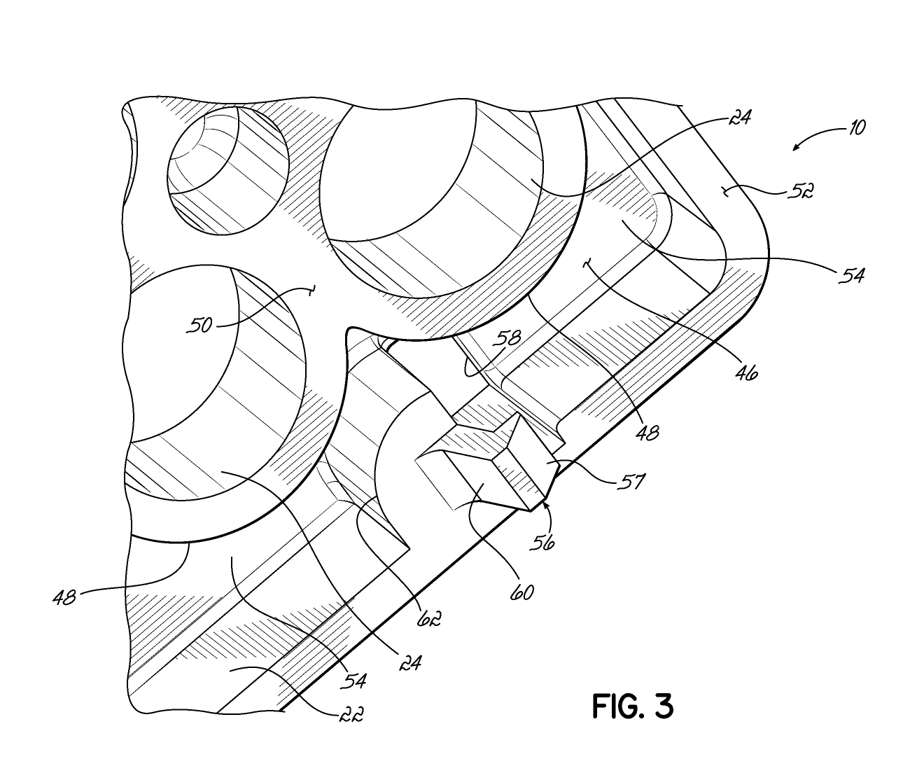

The bottom view of the tray 10 (e.g., FIG. 2) also illustrates a plurality of locking elements 56 that extend below the bottom surface 50, i.e., the second plane 52. More particularly, the locking elements 56 may comprise a hook 57 operably coupled to the tray 10 via an arm 60, which is more clearly shown in FIG. 3. The arm 60 may be coupled to the tray 10 at a lug 62, as shown, or may be directly or indirectly coupled to one of the bottom surface 46, the annular sleeve 48, the bottom surface 50, the sleeve bottom edge 52, or any other suitable surface of the tray 10.

The locking elements 56 may be constructed as a unitary structure with the tray 10 or may be coupled to the tray 10 after molding is complete. The locking elements 56 are configured to secure the tray 10 to the rack 44, as provided in greater detail below.

While not required, deck 12 may include an opening 58 over each locking element 56. The opening 58 may provide access to the locking element 56 after the tray 10 is coupled to rack 44. In some embodiments, it may be preferable to not permit such access to the locking element 56 by the end user.

Referring now to FIG. 4, with further reference to FIG. 1, additional detail of the multi-use pipette rack 44 is shown. The rack 44 may be constructed in accordance with the standards set forth by the American National Standards Institute (“ANSI”) and, in some instances, meets the Standards ANSI/SBS 1-2004 through ANSI/SBS 4-2004. In this way, the rack 44 may be adapted for a plurality of uses and instrumentations, including automations and robotic liquid handling systems regardless of a particular brand or manufacturer. While the rack 44 of the present invention is described as having the standardized dimensions, it would be appreciated that the rack may be otherwise configured. A tray may then be adapted for use with the rack while including one or more features in accordance with the spirit of the present invention.

Generally, the rack 44 includes a recessed surface 64 having a plurality of apertures 66 therein. It would be ready appreciated that the plurality of apertures 66 is arranged in a manner that is generally similar to the arrangement of the shaft apertures 24 (FIG. 1) described above. The shape and size of the shaft apertures 24 (FIG. 1) need not be exactly similar to the size of the plurality of apertures 66. Instead, each of the plurality of apertures 66, as provided in this particular embodiment, is shaped and sized to be in compliance with the standardizations described above, particularly for a 96-well microplate. Briefly, each aperture 66 has a diameter, d₁ while each of the shaft apertures 24 (FIG. 1) of the tray 10 (FIG. 1) may include a diameter, d₂ (FIG. 2), which no larger than d₁.

For example, in FIG. 1, the diameter, d₂ (FIG. 2), of each shaft aperture 24 is approximately equal to the diameter, d₁, of the recessed surface 64. In other embodiments, not specifically shown herein, the shaft apertures 24 may be have a diameter, d₂, which is much smaller than the aperture diameter, d₁, such that the shaft apertures 24 are configured to receive a shaft of a small volume pipette tip. Importantly, while the diameter of the shaft apertures 24 may vary from the diameter of the apertures 64 of the recessed surface 64, the shaft apertures 24 should be arranged to be in vertical alignment with the apertures 66 of the rack 44 when the tray 10 is positioned over the rack 44. In this way, the recessed surface 64 may receive various tray-configurations, or specifically, one tray-configuration for each discrete pipette tip size, so long as the shaft of the pipette tip is shaped and sized to be received by, and be in slidable relation with, the apertures 66 of the recess surface 64.

The rack 44 may further include sidewalls 68 that are, again, sized in accordance with the standards described above. Generally, the sidewalls 68 are sufficiently tall to receive the distal tip ends 32 (FIG. 1) of the pipette tips 28 (FIG. 1) when the pipette tips 28 (FIG. 1) are inserted into the tray 10 and positioned over the rack 44. The rack 44 may also include a base portion 70 that may snap onto, or otherwise be fixed to, the sidewalls 68, thus enclosing the distal tip ends 32 (FIG. 1) of the pipette tips 28 (FIG. 1) within a volume enclosed by the rack 44.

As alluded to previously, the rack 44 may be constructed from a molded polymer and include one or more ribs 42 for increased structural strength. The ribs 42 may extend the length of each sidewall 68, i.e., extending above the recessed surface 64. In another embodiment, the ribs 42 may extend only a portion of the length of the sidewall 68, within the volume of the rack 44 and up to, but not extending above, the recessed surface 64.

In the illustrative embodiment, the recess surface 64 includes a plurality of eyelets 72, wherein the central portion of each eyelet 72 may include a molded insert 74 that effectively closes the eyelet 72. While the plurality of eyelets 72 is shown to be aligned with the pair of lateral side edges 18, 20, it would be readily understood that the particular arrangement is not required and may vary in accordance with the particular laboratory application. The plurality of eyelets 72 may provide a number of alternate and/or additional functions, including for example, alignment within robotics, pipette tip identification. Specifically herein, the plurality of eyelets 72 is configured to be a receiving element for forming a locking engagement with locking elements 56, as described below.

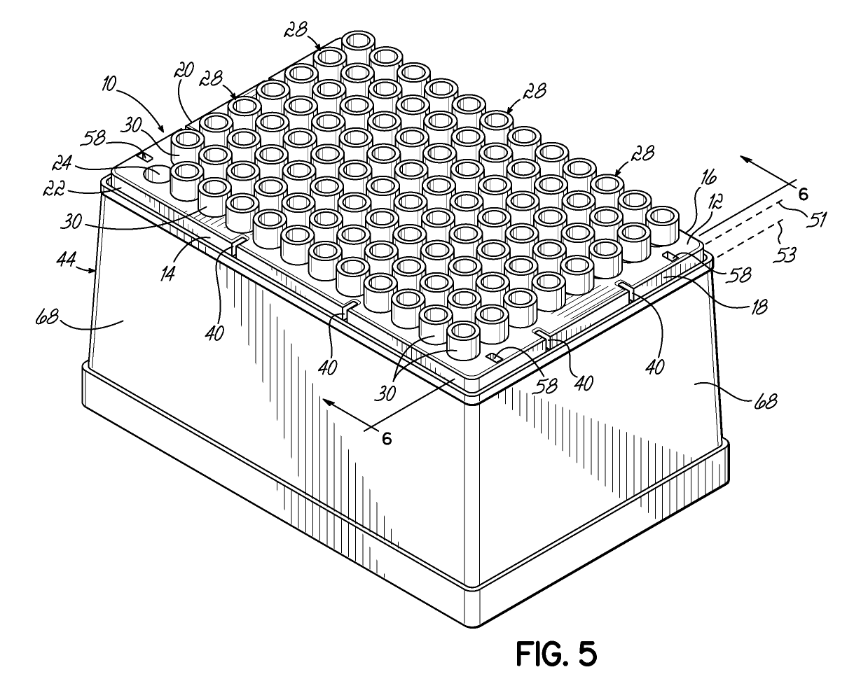

Turning now to FIG. 5, with additional reference to FIG. 1, a method of assembly for the tray 10 with the rack 44 is described in detail. The tray 10, generally with the pipette tips 28 pre-loaded in the shaft apertures 24, is positioned over the recessed surface 64 of the rack 44 and such that the distal tip ends 32 of each pipette tip 28 aligns with a respective one of the plurality of apertures 66 in the recessed surface 64. The tray 10 is directed toward the recessed surface 64 such that the slots 40 of the tray 10 align with the ribs 42, if present, of the rack 44.

With further advancement, each of the locking elements 56 resides above, and is adjacent to, a respective eyelet 72. Still further advancement causes the locking elements 56 to place a downwardly directed force onto the molded insert 74 of the eyelet 72, which is configured to be released, or snapped from the eyelet 72, with applied pressure from the locking element 56. As the molded insert 74 is released, the locking element 56 is biased slightly inwardly until the locking element 56 passes through the eyelet 72 and is released.

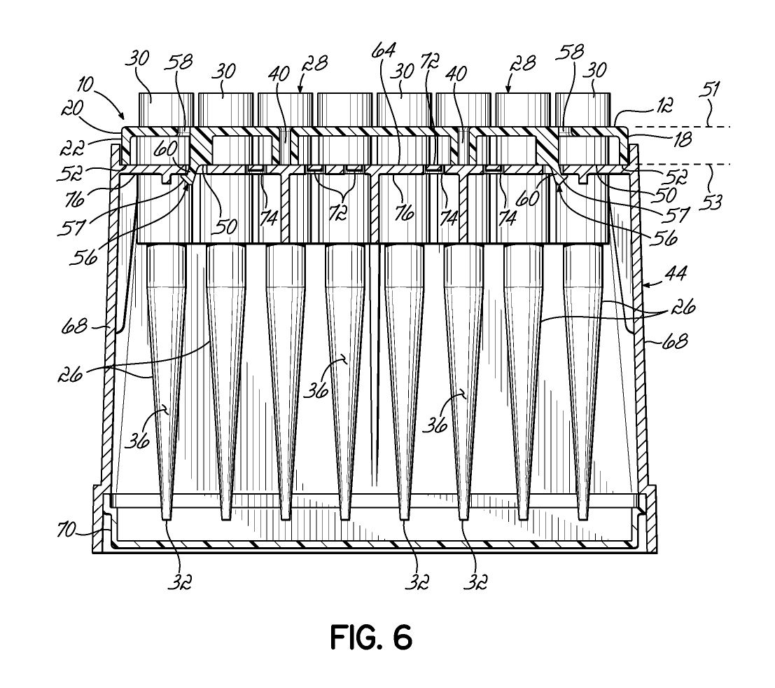

Turning now to FIG. 6, once the tray 10 is seated on the recessed surface 64, the locking elements 56 extend below a bottom edge 76 of the eyelet 72 and, being unconstrained by the eyelet 72, springs outward to its resting state. The arm 60 extends through the eyelet 72, the hook 57 is positioned adjacent the bottom edge 76 of the locking element 56, and resists removal of the tray 10 from the rack 44.

It would be readily understood that the molded inserted 74 could be snapped from the eyelet 72 prior to directing the tray 10 onto the rack 44. Furthermore, it would be understood that the bottom portion may be coupled to the sidewalls of the rack before or after the tray is coupled to the rack.

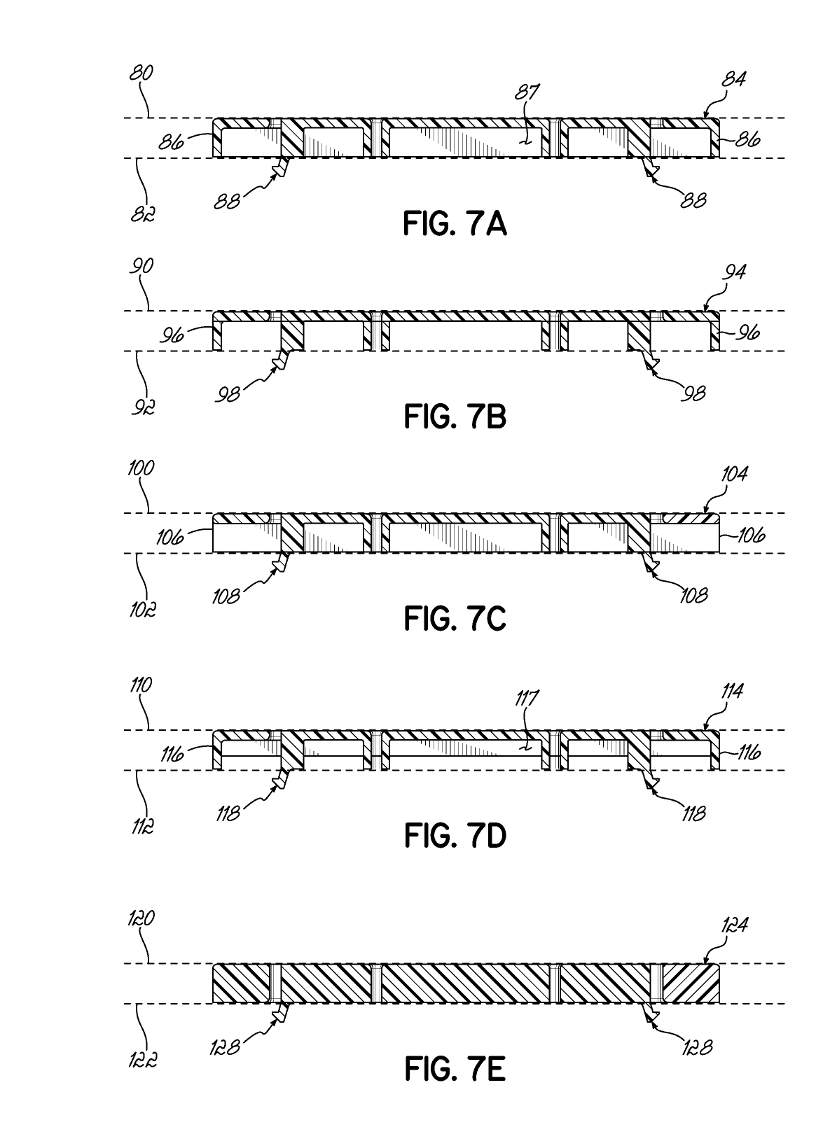

FIGS. 7A-7E illustrate other pipette tip trays in accordance with various other embodiments of the present invention. For example, in FIG. 7A, the pipette tip tray 84 includes a first plane 80 coinciding with a top surface and two pair of opposing sidewalls 86, 87 (though only one of the sidewalls 87 is shown) depending from the top surface 84. As shown, the locking elements 88 extend below a second plane 82, which coincides with lower most edge of the sidewalls 86, 87.

In FIG. 7B, the pipette tip tray 94 includes a first plane 90, again coinciding with a top surface, and only one pair of opposing sidewalls 96 (shown herein as a pair of lateral sidewalls 96). The locking elements 98 thus extend below a second plane 92 defined by the lower most edge of the one pair of lateral sidewalls 96.

The pipette tip tray 104 of FIG. 7C is similar to the pipette tip tray 94 of FIG. 7B but for the lateral sidewalls 96 (FIG. 7B) are replaced with one pair of opposing longitudinal sidewalls 106. Again, the locking elements 108 extend below a second plane 102, which is defined herein as the lower most edge of the one pair of longitudinal sidewalls 106.

FIG. 7D illustrates one embodiment of a pipette tip tray 114 having a first plane 110 coinciding with a top surface and two pair of opposing sidewalls 116, 117, wherein the lateral sidewalls 116 have a length that is greater than a length of the longitudinal sidewalls 117. As a result, the locking elements 118 extend below the lower most edge of the pair of lateral sidewalls 116, which define the second plane 112. While not shown, it would be understood that pipette tip tray could be constructed that include longitudinal sidewalls having a length greater than a length of the lateral sidewalls.

In FIG. 7E, the pipette tip tray 124 is constructed as a solid block such that the top surface defines the first plane 120 and the bottom surface defines the second plane 122. As before, the locking elements 128 extend below the second plane 122.

The pipette tip trays and methods of using the same as provided by the various embodiment of the present invention greatly simplifies the conventional method of coupling a pipette tip tray to a rack while maintaining tray variability and customization. That is, the locking element provides a structurally secured system without the use of adhesives or specialized tools.

While the present invention has been illustrated by a description of various embodiments, and while these embodiments have been described in some detail, they are not intended to restrict or in any way limit the scope of the appended claims to such detail. Additional advantages and modifications will readily appear to those skilled in the art. The various features of the invention may be used alone or in any combination depending on the needs and preferences of the user. This has been a description of the present invention, along with methods of practicing the present invention as currently known. However, the invention itself should only be defined by the appended claims.

What is claimed is:

1. A pipette tip tray configured to be secured to a rack, the pipette tip tray comprising:
an uppermost surface defining a first plane;
a lowermost surface defining a second plane;
a deck located between the first and second planes;
a plurality of shaft apertures, each of the plurality of shaft apertures extending through the deck and has a size or shape configured to receive a shaft of a pipette tip; and
a first locking element located below the second plane.

2. The pipette tip tray of claim 1, wherein the deck includes a pair of opposing longitudinal edges and a pair of opposing lateral edges.

3. The pipette tip tray of claim 2, further comprising:
a skirt coupled to the deck and having a bottom edge that is co-planar with the second plane.

4. The pipette tip tray of claim 3, wherein the skirt includes a pair of opposing walls located proximate the pair of opposing longitudinal edges.

5. The pipette tip tray of claim 3, wherein the skirt includes a pair of opposing sidewalls located proximate the pair of opposing lateral edges.

6. The pipette tip tray of claim 1, further comprising:
a second locking element located below the second plane, wherein the first and second locking elements are positioned on opposing ends of the tray.

7. The pipette tip tray of claim 1, wherein the first locking element includes a hook that is located below the second plane.

8. A pipette rack assembly, comprising:
(a) a pipette tip tray comprising:
(i) an uppermost surface defining a first plane;
(ii) a lowermost surface defining a second plane;
(iii) a deck located between the first and second planes;
(iv) a plurality of shaft apertures, each of the plurality of shaft apertures extending through the deck and has a size or shape configured to receive a shaft of a pipette tip; and
(v) at least one locking element located below the second plane;
(b) a rack comprising:
(i) a surface configured to receive the pipette tip tray;
(ii) at least one sidewall extending downwardly from the surface; and
(iii) at least one receiving element on the surface of the rack and vertically aligned with the at least one locking element of the pipette tip tray when the pipette tip tray is positioned over the rack,
wherein the at least one locking element is configured to be coupled to the at least one receiving element to secure the pipette tip tray to the rack.

9. The pipette rack assembly of claim 8, wherein the pipette tip tray further comprises a skirt coupled to the deck and having a bottom edge that is co-planar with the second plane.

10. The pipette rack assembly of claim 8, wherein the at least one locking element is a hook and the at least one receiving element is an eyelet.

11. The pipette rack assembly of claim 10, wherein the eyelet includes an insert positioned within and closing the eyelet, the insert configured to be broken away from the eyelet.

12. The pipette rack assembly of claim 8, wherein the at least one receiving element is a plurality of eyelets.

13. The pipette rack assembly of claim 12, wherein a select one of the plurality of eyelets receives the at least one locking element of the pipette tip tray.

14. A variable pipette rack system, comprising:
(a) a plurality of pipette tip trays, each of the plurality of pipette tip tray comprising:
(i) an uppermost surface defining a first plane;
(ii) a lowermost surface defining a second plane;
(iii) a deck located between the first and second planes;
(iv) a plurality of shaft apertures, each of the plurality of shaft apertures extending through the deck and has a size or shape configured to receive a shaft of a pipette tip; and
(v) at least one locking element located below the second plane; and
(b) a rack comprising:
(i) a surface configured to receive a select one of the plurality of pipette tip trays;
(ii) at least one sidewall extending downwardly from the surface; and
(iii) a plurality of receiving elements on the surface, at least one of the plurality of receiving elements being in vertical alignment with the at least one locking element of a select one of the plurality of pipette tip trays when the select one of the plurality of pipette tip trays is positioned over the rack,
wherein the at least one locking element of the select one of the plurality of pipette tip trays is configured to be coupled to a corresponding one of the plurality of receiving elements and to secure the select one of the plurality of pipette tip trays to the rack.
